(19) United States
(12) Patent Application Publication
(10) Pub. No.: US 2012/0021314 A1
(43) Pub. Date: Jan. 26, 2012

(54) SOLID OXIDE FUEL CELL WITH INTERNAL REFORMING MEMBER

(75) Inventors: Aaron Crumm, Ann Arbor, MI (US); Timothy LaBreche, Ann Arbor, MI (US); Shaowu Zha, Ann Arbor, MI (US)

(73) Assignee: ADAPTIVE MATERIALS, INC., Ann Arbor, MI (US)

(21) Appl. No.: 12/843,397

(22) Filed: Jul. 26, 2010

(51) Int. Cl. H01M 8/06

(52) U.S. Cl. 429/423

(57) ABSTRACT

A solid oxide fuel cell module includes a fuel cell tube defining a fuel cell tube inner chamber. The fuel cell tube includes a fuel cell tube inlet, a fuel cell tube outlet, and an active portion comprising an anode layer, a cathode layer, and an electrolyte layer. The active portion is configured to react an oxidizing fluid and a reducing fluid to generate an electromotive force. The solid oxide fuel cell module further includes an internal reforming member disposed within the fuel cell tube, the internal reforming member being configured to receive raw fuel and convert raw fuel to reformed fuel. The solid fuel cell tube further includes an anode current collector disposed within the fuel cell tube, the anode current collector connected to the anode layer of the anode current collector and providing support to the internal reforming member such that the internal reforming member retains a desired position within the fuel cell tube.

### FIELD OF THE DISCLOSURE

The disclosure relates to fuel cells and more particularly to solid oxide fuel cells with fuel reforming.

### BACKGROUND

Fuel cells convert chemical energy to electrical energy, forcing electrons to travel through an electric circuit. The fuel cell includes two electrodes disposed on opposite sides of an electrolyte. The fuel cell includes an electrode configured to catalyze a reducing reaction and an electrode configured to catalyze an oxidizing reaction.

Solid oxide fuel cells are fuel flexible in that various fuel types can be utilized by the fuel cell. Reforming, a fuel processing step, renders hydrocarbon fuels (such as propane, butane, ethanol, methanol, gasoline, diesel fuel, and military fuels) suitable for solid oxide fuel cell reactions, wherein the reformed fuel can react with oxygen ions to generate DC current. Non hydrocarbon fuels such as ammonia can also be transformed into solid oxide fuel cell fuel using one or more catalytic reactions. U.S. patent application Ser. No. 10/979,017, the contents of which are incorporated by reference herein in its entirety, sets forth a tubular solid oxide fuel cell with internal fuel processing. Fuel cell systems utilizing internal fuel processing have increased fuel cell stack efficiency and decreased system costs over fuel cell systems utilizing external fuel processing.

Robust fuel cells that utilize low cost manufacturing processes will increase fuel cell penetration within the commercial marketplace. Increasing the energy conversion efficiency of fuel cells will further expand fuel cell penetration into the commercial marketplace. For example, high energy conversion efficiencies can be achieved through controlled pressure differentials that allow substantially equal fuel distribution through each of the tubes of the fuel cell stack and higher energy conversion efficiencies can be achieved through improved catalytic reactor designs. Therefore, fuel cells with the design improvements to increase robustness, manufacturability and efficiency are desired to further adoption of commercial fuel cell systems.

### SUMMARY

A solid oxide fuel cell module includes a fuel cell tube defining a fuel cell tube inner chamber. The fuel cell tube includes a fuel cell tube inlet, a fuel cell tube outlet, and an active portion comprising an anode layer, a cathode layer, and an electrolyte layer. The active portion is configured to react an oxidizing fluid and a reducing fluid to generate an electromotive force. The solid oxide fuel cell module further includes an internal reforming member disposed within the fuel cell tube, the internal reforming member being configured to receive raw fuel and convert raw fuel to reformed fuel. The solid fuel cell tube further includes an anode current collector disposed within the fuel cell tube, the anode current collector connected to the anode layer of the anode current collector and providing support to the internal reforming member such that the internal reforming member retains a desired position within the fuel cell tube.

### DESCRIPTION OF THE FIGURES

FIG. 1 is a cross-sectional view of a fuel cell stack in accordance with an exemplary embodiment of the present disclosure;

FIG. 2 is an exploded perspective view of a portion of the fuel cell stack of FIG. 1;

FIG. 3 is a perspective view of the portion of the fuel cell stack of FIG. 2;

FIGS. 4A-4D are top down views of exemplary reforming reactors in accordance with exemplary embodiments of the present disclosure; and

FIG. 5A-5B are perspective views of a fuel cell tube and a cathode current collector in accordance with a second exemplary embodiment of the present disclosure.

It should be understood that the appended drawings are not necessarily to scale, presenting a somewhat simplified representation of various preferred features illustrative of the basic principles of the invention. The specific design features of the fuel cell as disclosed herein will be determined in part by the particular intended application and use environment. Certain features of the illustrated embodiments have been enlarged or distorted relative to others for visualization and clear explanation. In particular, thin features may be thickened, for example, for clarity of illustration.

### DETAILED DESCRIPTION

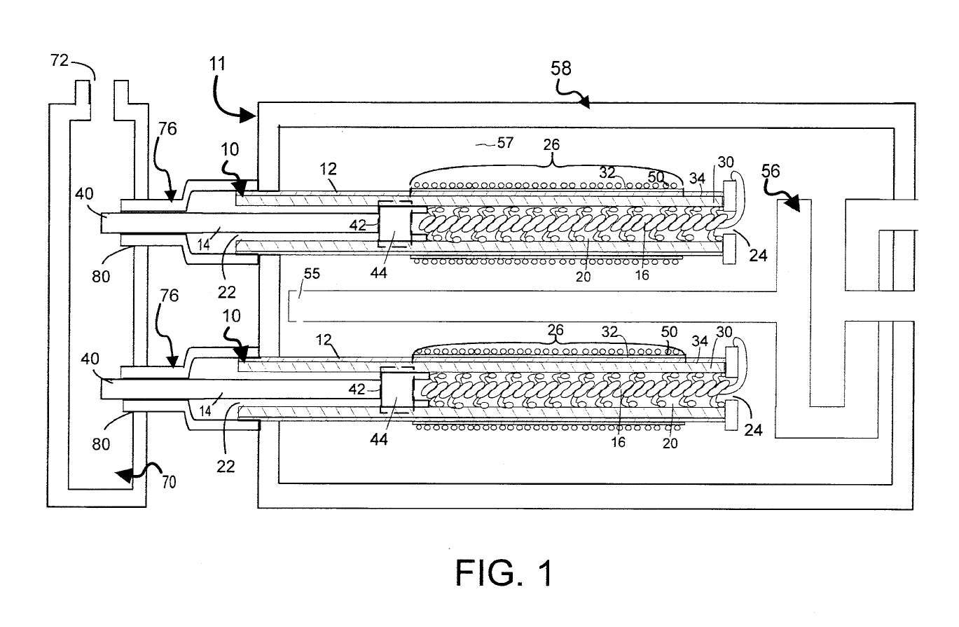

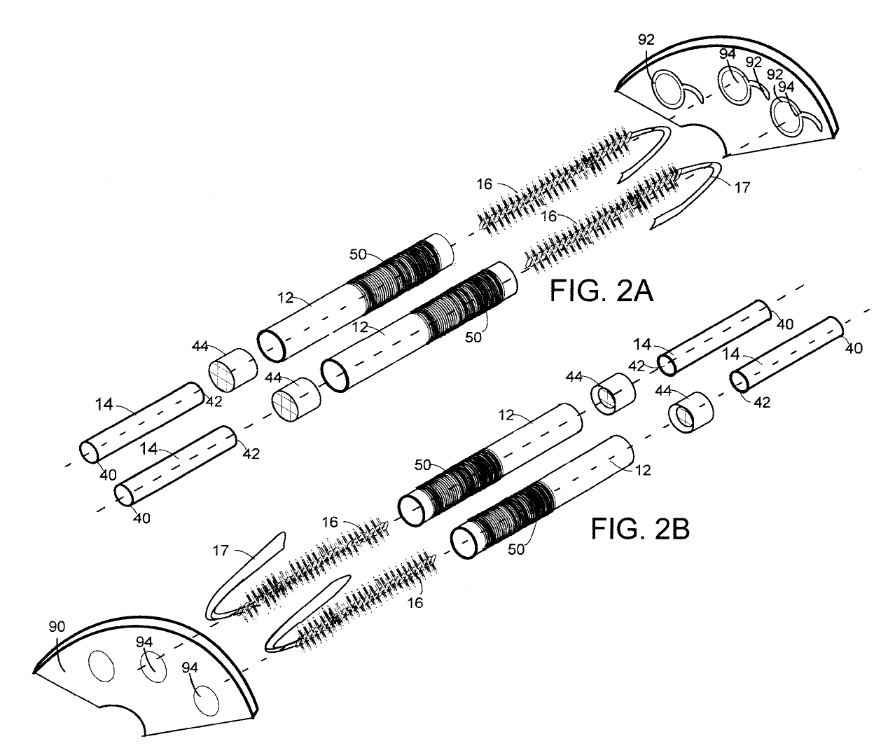

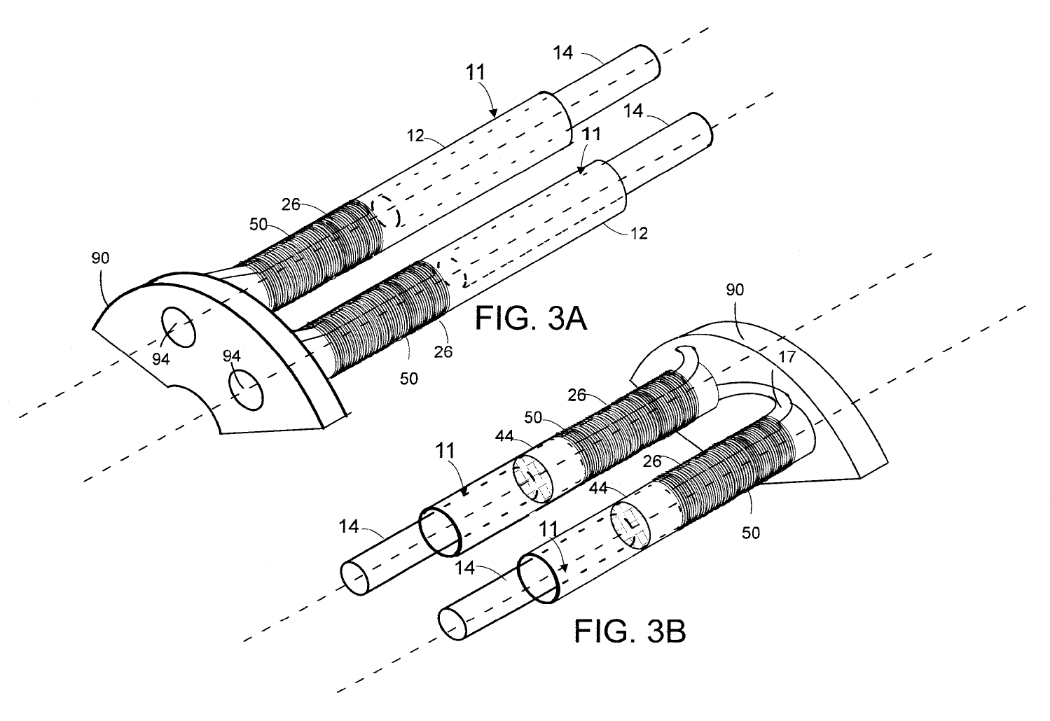

Referring to the figures, wherein exemplary embodiments are described and wherein like elements are numbered alike, FIGS. 1-3 depict various views of an exemplary fuel cell stack 11 including fuel cell tube modules 10. The fuel cell tube modules 10 are configured to input raw fuel, convert raw fuel to reformed fuel, and to generate electricity by electrochemical reactions with reformed fuel and oxidizing fluid. The fuel cell modules 10 each include a fuel cell tube 12, a fuel feed tube 14, an internal reforming member 44, an anode current collector 16, and a cathode current collector 50.

Although two fuel cell tube modules are shown in the cross sectional depiction of FIGS. 1-3, fuel cell stacks can be configured to operate with several different tube quantities (e.g., one to several thousand) and configurations, and exemplary tubular stack configurations described herein should be understood as not limiting on the scope of the disclosure. The particular views depicted in FIGS. 1-3 are portions of a fuel cell tube stack having a substantially circular array of tubes. The fuel cell stack 11 further includes a recuperator 56, insulated walls 58 defining an insulated chamber 57, a manifold member 70, and manifold connecting members 76.

The fuel cell tube 12 defines a fuel cell tube inner chamber 20 disposed between a fuel cell tube inlet 22 and a fuel cell tube outlet 24. The terms “inlet” and “outlet” are used in the specification with reference to the general fluid flow direction within each fuel cell tube module 10 of the fuel cell stack 11. Thus, when referring to fuel cell tube 12, fuel (i.e. raw fuel) and air enter the fuel cell tube through the fuel cell tube inlet 22 and exhaust fluid (i.e. reacted fuel, water vapor, and unutilized air) exits the fuel cell tube through the fuel cell tube outlet 24. The terms upstream and downstream are used in the specification to designate the position of a first fuel cell stack component relative to a second fuel cell stack component with reference to the general fluid flow direction within the fuel cell stack 11.

Each of the fuel cell tubes 12 can be manufactured utilizing a co-extrusion process as described in U.S. Pat. No. 6,749,799 entitled “Method for Preparation of Solid State Electrochemical Device”. In alternate embodiments, other processes such as single layer extrusion, spray forming, casting and screen-printing can be utilized in manufacturing the fuel cell tube.

Further, as used herein, the term “tube” refers to any structure generally configured to direct fluid. Although the exemplary fuel cell tube comprises a continuously enclosed circular cross-section, in an alternate embodiment, alternate geometries can be utilized and the cross-section does not have to be fully enclosed. Exemplary alternate geometries include polygonal shapes, for example rectangular shapes, and other ovular shapes.

Each fuel cell tube 12 includes an active portion 26. The active portion 26 refers to the portion of the fuel cell tube generating electromotive force and the active portion 26 includes an anode layer 30, an electrolyte layer 34, a cathode layer 32, and can further include other layers such as anode functional layers and reactivity barrier layers to provide selected electrical, electrochemical and catalytic properties.

The anode layer 30 comprises an electrically and ionically conductive ceramic-metallic material that is chemically stable in a reducing environment. In one exemplary embodiment, the anode layer 30 is a porous structure comprising a conductive metal such as nickel, disposed in a ceramic skeleton, such as yttria-stabilized zirconia.

The electrolyte layer 34 is a substantially dense layer configured to conduct ions between the anode layer 30 and the cathode layer 32. The exemplary electrolyte layer 34 can include lanthanum-based materials, zirconium-based materials and cerium-based materials such as lanthanum strontium gallium manganite, yttria-stabilized zirconia and gadolinium doped ceria, and the electrolyte layer 34 can further include various other dopants and modifiers to affect ion conducting properties.

The cathode layer 32 comprises an electrically conductive material that is chemically stable in an oxidizing environment. In an exemplary embodiment, the cathode layer 32 comprises a perovskite material and specifically comprises lanthanum strontium cobalt ferrite (LSCF).

An outer current collector 50 is disposed in electrical contact with the cathode layer 32. The outer current collector 50 includes a longitudinal portion and an axial portion. The longitudinal portion comprises a portion of a wire 17. The axial portion comprises one or more wires wrapped around the outer circumference of the fuel cell tube 12. In exemplary embodiment, current carrier wire comprises silver, however, in alternate embodiments other materials capable of conducting current in high temperature oxidative environments can be used.

The anode current collector 16 comprises material generally configured to collect and conduct electrons between anode layer 30 of a first fuel cell tube and either a cathode layer or an anode layer of a second fuel cell tube depending on whether the fuel cell tubes are connected in series or parallel electrical connections. In one embodiment the anode current collector 16 comprises copper, and can comprise features for electrically connecting and mechanically fastening the fuel cell tube to a flow distribution portion (not shown) and a power routing portion (not shown) of the fuel cell stack 11. The anode current collector 16 comprises a wire brush structure having an inner conductive core and outer resilient brush bristles that can provide desired locating and tolerancing characteristics to enhance connection within the inner wall of the fuel cell tube 12. The anode current collector 16 can be inserted into the fuel cell tube 12 through either the fuel cell tube inlet or the exhaust outlet. When inserted into the fuel cell tube 12, the anode current collector 16 provides structural support to the fuel cell tube 12. An anode contact layer (not shown) can be deposited within the fuel cell tube 12 by injecting a slurry into the fuel cell tube 12 at either end of the fuel cell tube 12 and subsequently flowing air or other fluid through the fuel cell tube 12 such that the air forces the selected amount of slurry through the fuel cell tube 12 thereby selectively depositing a portion of the slurry onto portions of the anode current collector 16 and the anode layer 30, while allowing a portion of the slurry to exit the tube. By flowing air through the fuel cell tube 12, the slurry can be distributed on surfaces throughout the entire length of the anode current collector 16 coating the loop members filling the gap area between the anode current collector 16 and the anode layer 30. When the slurry is sintered, the anode current collector 16 is fixedly positioning within the fuel cell tube and the sintered slurry provides high levels of electrical conductivity between the anode current collector 16 and the fuel cell tube 12.

The slurry can comprise conductive material compatible with the anode layer 30 along with organic or aqueous solvents and corresponding binders. The solvents and binders are burned off during the sintering process. In an exemplary embodiment, the slurry comprises nickel oxide and samarium-doped cesium along with an organic solvent and binder. The binder and solvent are burned off and nickel oxide is reduced to nickel when the fuel cell tube 18 is sintered in a reducing environment. In alternate embodiments, other joining methods can be utilized to electrically and physically couple the anode current collector 16 to the anode layer 30. For example, other brazing or welding methods can be utilized. Exemplary braze materials include braze materials comprising nickel with or without a secondary material and can further include any one more of silver, sulfur, silicon chromium, bismuth.

The fuel feed tube 14 comprises a fuel feed tube inlet 40 and a fuel feed tube outlet 42. The fuel feed tube 14 comprises a dense ceramic material compatible with the high operating temperatures within the insulated chamber 57, for example, an alumina based material or a zirconia based material.

The recuperator 56 is provided to transfer heat between fuel cell exhaust and a cathode air input stream entering the insulated chamber 57. In an exemplary embodiment, the recuperator 56 comprises a multi-stage, stainless steel heat exchanger compatible with the operating temperatures and operating environment within the insulated chamber 57.

The insulated walls 58 thermally insulate the active portions 26 of the fuel cell modules 10 to maintain a desired operating temperature. The insulated walls 58 can comprise ceramic-based material tolerant of high temperature operation, for example, microporous materials, foam, aero-gel, mat-materials, and fibers formed from, for example, alumina, silica, and like materials.

The manifold member 70 comprises an inlet opening 72 and a plurality of outlet openings 80 wherein connector tubes 76 and fuel feed tubes 14 are disposed through the outlet openings 80. A polymer sealant (not shown) bonds with the different components of the fuel cell stack 10 and can maintain a gas tight seal under the operating conditions of the fuel cell stack 10. In particular, the polymer sealant is disposed around the outer circumference of the connector tubes 76. The connector tubes 76 can be stepped such that the connector tubes have a first inner diameter configured to receive the fuel cell tube 12 and a second inner diameter configured to receive the fuel feed tube 14. The connector tubes 76 comprise low-temperature, resilient and mechanically compliant materials such as silicone-based polymers. The term “mechanically compliant” as used herein, refers to the ability of the connector tubes to allow movement of the manifold member 72 relative to the plurality of fuel feed tube 14 such that shocks and movements associated with the manifold member may be absorbed by the connector tubes 76. The connector tubes 76 can maintain gas-tights seals between an inner chamber of the manifold member 70 and each fuel feed tube inlet 40. In one embodiment, the connector tubes 26 comprise a flexible silicone-base polymer.

A flame protection member 90 is provided to protect the fuel cell tubes 12 and the current collection components of the fuel system 11 from a high temperature, combustion environment of a flame region. The flame region is the region wherein unspent fuel within an exhaust stream of the fuel cell tubes reacts with oxygen outside the fuel cell tubes in a combustion reaction. The flame protection member 90 includes holes 94 permitting the flow of exhaust gas therethrough and further includes recessed portion 92 configured to support an end of the fuel cell tube 12 and to support one or more wires 17 interconnecting fuel cell tubes.

The exemplary flame protection member 90 can provide a physical barrier, an oxygen barrier and a thermal barrier between the flame region and each fuel cell tube 12. The exemplary flame protection member 90 comprises a high temperature ceramic material, for example, alumina, and zirconia materials.

The internal reforming member 44 is provided to convert propane and butane along with other hydrocarbon fuel such as those described in U.S. patent application Ser. No. 10/979,017 to fuel that can be utilized in the electrochemical reactions of the fuel cell tube 12. The internal reforming member 44 is disposed within the inner chamber 20 of the fuel cell tube 12 between the fuel feed tube 14 and the anode current collector 16 proximate to an end of the active portion 26.

The fuel cell tube 12 including the internal reforming member 44 is designed for high volume manufacturing and high operational robustness. In an exemplary manufacturing process, the anode current collector can be connected a portion of the inner circumference of the tube 12, and the internal reforming member 44 can be subsequently placed through the inlet end 22 of the fuel cell tube 12. The fuel feed tube 14 can then be forced against the internal reforming member 44 positioning the internal reforming member 44 in the fuel cell tube 12 without requiring extensive utilization of sealant material between the fuel feed tube 14 and fuel internal reforming member 44, thereby eliminating a potential failure mode of the fuel cell stack 11. In one embodiment, the anode current collector 16 directly contacts the internal reforming member 44 of the fuel cell tube 12, thus directly engaging and supporting the internal reforming member 44. In one embodiment, the anode current collector 16 contacts one or more intermediate members between the internal reforming 44 and the anode current collector, thus indirectly engaging and supporting the internal reforming member 44.

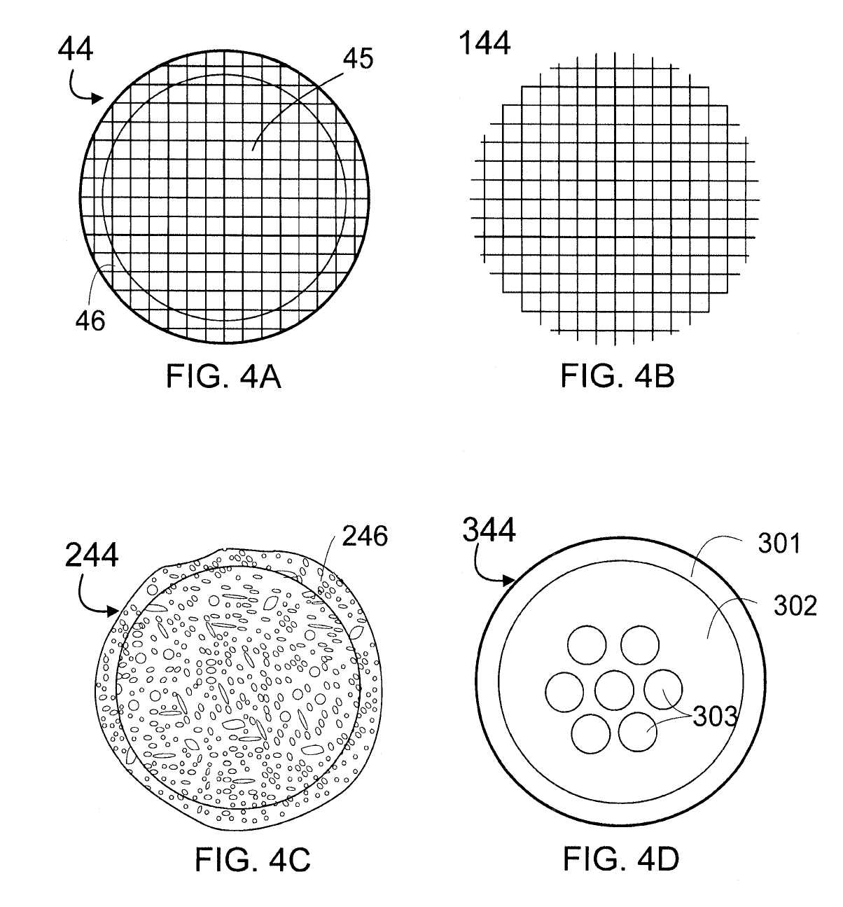

Referring to FIGS. 4A-4D, depicted are a top down view of the internal reforming member 44 of exemplary fuel cell stack 11, along with top down views of an internal reforming member 144, an internal reforming member 244, and internal reforming member 344, each which can be utilized in alternate fuel cell stack embodiments.

Referring to FIG. 4A the exemplary fuel reforming member 44 comprises a honeycomb-like structure with densely packed parallel channels. The walls of the channels provide the surface for the reforming catalyst. In particular, the exemplary substrate properties include high surface area, low pressure drop, rapid light-off and thermal-mechanical durability. Exemplary substrate materials include ceramic materials such as alumina based materials, zirconia based materials, corderite materials, and other like catalytic substrate materials.

During operation, the exemplary fuel reforming member 44 has a temperature gradient across its geometry and fuel is directed to a high temperature, central portion of the fuel reforming member 44. The portion of the fuel reforming member utilized for reforming is thermal shielded. Thus, the catalytic reaction is not susceptible to quenching through thermal conduction with other members of the fuel cell stack 10.

The fuel reforming member 44 comprises a catalytic portion 45 and a spacing portion 46. The catalytic portion 45 can comprise catalytic particles disposed on the substrate. Exemplary catalytic particles include metals such as platinum or other noble metals such as palladium, rhodium, iridium, osmium, and alloys thereof. The spacing portion 46 provides thermal insulation between the catalytic portion 45 and the anode current collector 16 to maintain desired light-off temperatures within the catalytic portion 45. Desired light-off can be achieved without utilizing a spacing portion by, for example desired catalyst distribution providing a desired light-off location. Fuel can be routed through the reforming member 44 such that substantially no unreformed fuel contacts the anode layer 30 of the fuel cell tube 12.

The internal reforming member 144 comprises catalyst material disposed on a substrate having a similar honeycomb-like structure to the substrate of the internal reforming member 44. However, the internal reforming member 144 does not include an outer wall and does not include a spacing member.

The internal reforming member 244 comprises catalyst material disposed on a porous sponge-like ceramic substrate. In alternate embodiments, the ceramic substrate can comprise ceramic foams, fibers, mats, sintered bed, and other structures having desired surface area for catalyst loading and desired porosity levels for catalyst contact time and pressure drop level.

The internal reforming member 344 comprises a catalytic portion 302 and a spacing member 301. The catalytic portion 302 comprises a plurality of holes 303 disposed therethrough. The catalytic portion 302 comprises catalytic particles disposed on the substrate within the holes 303. Exemplary catalytic particles include metals such as those listed above with reference to the internal reforming member 44.

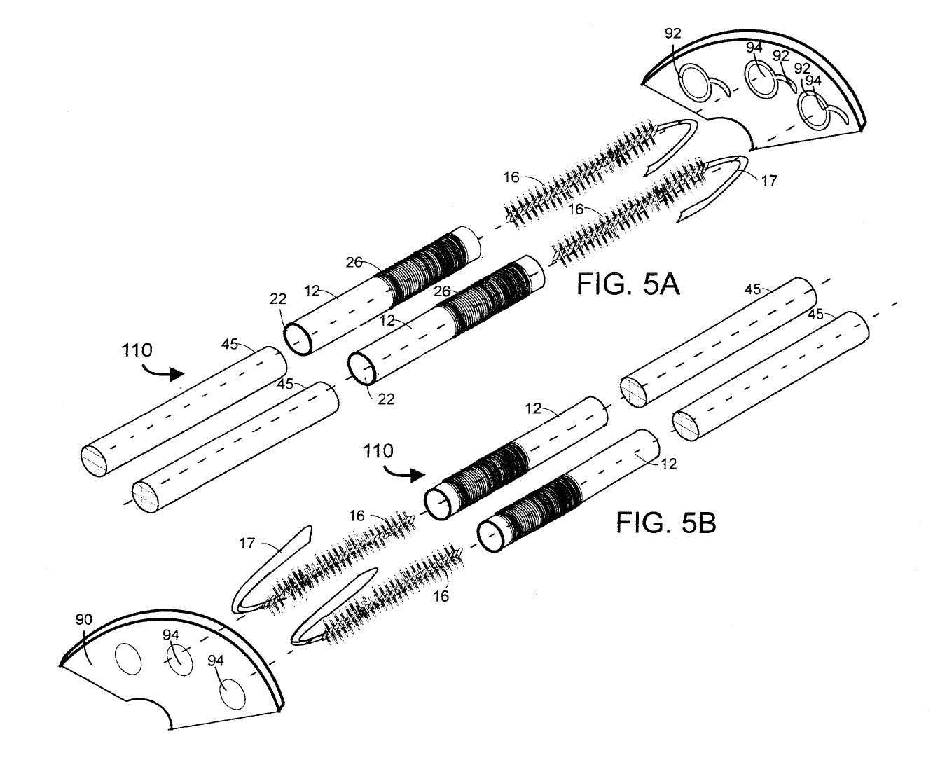

Referring to FIGS. 5A and 5B, a fuel cell module 110 are shown. The fuel cell modules 110 are similar to the fuel cell modules 10 as described above however, the fuel cell modules 110 comprise fuel reforming members 114 in place of the fuel feed tubes 12 and internal reforming member 44. The fuel reforming members 114 comprises a honeycomb-like structure with densely packed parallel channels similar to those described above with reference to the substrate of the fuel reforming member 44. The reforming member 114 includes metallic reforming catalysts disposed within the honeycomb in a region proximate an end of the fuel cell active portion 26. However, fuel reforming members 114 extend outside the inlet end 22 of the fuel cell tubes thereby replacing the fuel feed tube 14 of the embodiment of FIGS. 1-3.

The solid oxide fuel cell modules described can be rapidly and robustly manufactured. In particular, the solid oxide fuel cell modules comprise reforming members that are engaged by the fuel feed tube (i.e., a first positioning member) and an anode current collector (i.e., a second positioning member) without the use of adhesives. The lengths of the first positioning member can be utilized to provide desired positioning of the fuel cell module within the fuel cell tubes 12. Further, the fuel reforming members have higher efficiencies and have low pressure drops. Therefore, pressure drop can be controlled at other locations of the fuel cell stack, thereby allowing equal fuel distribution through each of the tubes of the fuel cell stack.

From the foregoing disclosure and detailed description of certain preferred embodiments, it will be apparent that various modifications, additions and other alternative embodiments are possible without departing from the true scope and spirit of the invention. The embodiments discussed were chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. A solid oxide fuel cell module comprising:
a fuel cell tube defining a fuel cell tube inner chamber, the fuel cell tube comprising a fuel cell tube inlet, a fuel cell tube outlet, and an active portion comprising an anode layer, a cathode layer, and an electrolyte layer, the active portion being configured to react an oxidizing fluid and a reducing fluid to generate an electromotive force;
an internal reforming member disposed within the fuel cell tube, the internal reforming member being configured to receive raw fuel and to convert raw fuel to reformed fuel; and
an anode current collector disposed within the fuel cell tube, the anode current collector connected to the anode layer of the fuel cell tube and engaging the internal reforming member such that the internal reforming member retains a desired position within the fuel cell tube.

2. The solid oxide of claim 1, wherein the internal reforming member is directly engaged by the anode current collector.

3. The solid oxide fuel cell tube 1, further comprising a fuel feed tube, wherein the internal reforming member is disposed between the fuel feed tube and the anode current collector.

4. The solid oxide fuel cell tube of claim 3, wherein the internal reforming member retained in a substantially fixed location by anode current collector and the fuel feed tube.

5. The solid oxide fuel cell of claim 1, wherein the internal reforming member extends from the anode current collector to the inlet end of fuel cell tube.

6. The solid oxide fuel cell of claim 1, wherein the internal reforming member comprises a honeycomb structure.

7. The solid oxide fuel cell of claim 1, wherein the internal reforming member comprises a catalytic region and a raised portion between the catalytic region and the anode current collector.

8. The solid oxide fuel cell of claim 1, wherein the internal reforming member comprises a plurality of holes disposed therethrough, wherein catalytic material is disposed within the holes.

9. The solid oxide fuel cell of claim 1, wherein the internal reforming member comprises one of a sponge material, a foam material, and a fibrous material.

10. The solid oxide fuel cell of claim 1, wherein fuel is directed to a catalyst of the internal reforming member prior to contact the anode of the fuel cell tube.

11. A solid oxide fuel cell tube comprising:
a fuel cell tube defining a fuel cell tube inner chamber, the fuel cell tube comprising a fuel cell tube inlet, a fuel cell tube outlet, and an active portion comprising an anode layer, a cathode layer, and an electrolyte layer, the active portion being configured to react an oxidizing fluid and a reducing fluid to generate an electromotive force;
an internal reforming member disposed through the fuel cell tube inlet and extending to location proximate the active area of the fuel cell tube, the internal reforming member being configured to receive raw fuel and convert raw fuel to reformed fuel; and
an anode current collector disposed within the fuel cell tube, the anode current collector being connected to the anode layer of the fuel cell tube and engaging the internal reforming member such that the internal reforming member retains a desired position within the fuel cell tube.

12. The solid oxide fuel cell of claim 11, wherein the internal reforming member comprising a honeycomb structure.

13. The solid oxide fuel cell of claim 11, wherein the internal reforming member comprises a catalytic region and a raised portion between the catalytic region and the anode current collector.

14. The solid oxide fuel cell of claim 11, wherein the internal reforming member comprises a plurality of holes disposed therethrough, wherein catalytic material is disposed within the holes.

15. The solid oxide fuel cell of claim 11, wherein the internal reforming member comprises one of a sponge material, a foam material, and a fibrous material.

16. A solid oxide fuel cell module comprising:
a fuel cell tube defining a fuel cell tube inner chamber, the fuel cell tube comprising a fuel cell tube inlet, a fuel cell tube outlet, and an active portion comprising an anode layer, a cathode layer, and an electrolyte layer, the active portion being configured to react an oxidizing fluid and a reducing fluid to generate an electromotive force;
an internal reforming member disposed within the fuel cell tube, the internal reforming member being configured to receive raw fuel and convert raw fuel to reformed fuel; and
an anode current collector disposed within the fuel cell tube, the anode current collector connected to the anode layer of the anode current collector and providing support to a first side of the internal reforming member such that the internal reforming member retains a desired position within the fuel cell tube, and
a fuel feed tube, wherein the fuel feed tube provides support to a second side of the internal reforming member.

17. The solid oxide fuel cell of claim 16, wherein the internal reforming member comprising honeycomb structure.

18. The solid oxide fuel cell of claim 16, wherein the internal reforming member comprises a catalytic region and a raised portion between the catalytic region and the anode current collector.

19. The solid oxide fuel cell of claim 16, wherein the internal reforming member comprises a plurality of holes disposed therethrough, wherein catalytic material is disposed within the holes.

20. The solid oxide fuel cell of claim 16, wherein the internal reforming member comprises one of a sponge material, a foam material, a sintered bed and a fibrous material.
